(19) United States
(12) Patent Application Publication
(10) Pub. No.: US 2019/0303763 A1
(43) Pub. Date: Oct. 3, 2019

(54) TRINARY NEURAL NETWORK AND BACK-PROPAGATION METHODOLOGY

(71) Applicant: CA, Inc., New York, NY (US)

(72) Inventor: Christopher Phillip Bonnell, Longmont, CO (US)

(21) Appl. No.: 15/940,906

(22) Filed: Mar. 29, 2018

(51) Int. Cl. G06N 3/08; G06N 3/04

(52) U.S. Cl. CPC G06N 3/084; G06N 3/0454

(57) ABSTRACT

A trinary neural network includes a plurality of voting neurons arranged in one or more layers. The voting neurons receive plurality of integer input values. The voting neurons determine, based at least in part on a set of voting coefficients, vote counts associated with a plurality of candidate output values, wherein the candidate output values indicate a vote for, a vote against, or an abstention. The voting neurons determine an output based, at least in part, on the vote counts. During a backpropagation stage, a backpropagation matrix is sampled to determine a sampled subset of the backpropagation matrix. For each entry in the sampled subset, a value is determined for a coefficient of a voting neuron associated with the entry in accordance with the entry.

### BACKGROUND

The disclosure generally relates to the field of data processing, and more particularly to modeling, design, simulation, or emulation.

Neural networks simulate the operation of the human brain to analyze a set of inputs and produce outputs. In conventional neural networks, neurons (also referred to as perceptrons) can be arranged in layers. Neurons in the first layer receive input data. Neurons in successive layers receive data from the neurons in the preceding layer. A final layer of neurons produces an output of the neural network. When a neuron receives input, it applies a set of learned coefficients to the input data to produce an output of the neuron. The coefficients of the neurons are learned through a process of training the neural network. A set of training data is passed through the network, and the resulting output is compared to a desired output. Error values can be calculated based on how different the resulting output is from the desired output. The error values can be used to adjust the coefficients. Repeated application of training data to the neural network can result in a trained neural network having a set of coefficients in the neurons such that the trained neural network can accurately classify data, recognize data, or make decisions about data in data sets that have not been previously seen by the neural network.

While neural networks can be useful for many types of classification, recognition, and decision making tasks, training a neural network to produce accurate results typically consumes large amounts of processor, memory and other resources of a computing system. Even operating a neural network can consume large amounts of processor and memory resources. For example, a typical neural network can use 64 bit floating point operations (addition, subtraction, multiplication, division etc.) during training and operations. As a result, it can be impractical operate a neural network on resource limited processor architectures that either don't have native support for floating point operations or where such operations take a relatively large amount of time. For example, embedded systems and other low-power systems typically do not have sufficient processor and memory resources to effectively implement a neural network.

Conventional systems have attempted to work around this problem by discretizing results during training. For example, a single training run may involve passing training data through the neural network, discretizing the output (e.g., translating the floating-point values to a corresponding range of integer values), and analyzing the results to see what happened. However, the process of discretizing the output can result in a loss of a large amount of information in the training phase, effectively destroying the usefulness of the training run. As a result, such training can effectively require restarting the process numerous times, resulting in an inefficient use of system resources.

### BRIEF DESCRIPTION OF THE DRAWINGS

Embodiments of the disclosure may be better understood by referencing the accompanying drawings.

FIG. 1 is a block diagram illustrating an example system for training and deploying a trinary neural network.

FIG. 2 is a block diagram illustrating an example trinary neural network.

FIG. 3 is a block diagram providing further details on a voting neuron 308 in an example trinary neural network.

FIG. 4 is a block diagram illustrating elements involved in backpropagation in an example trinary neural network.

FIG. 5 is a flow chart illustrating feedforward operations of a method for operating a trinary neural network.

FIG. 6 is a flow chart illustrating backpropagation operations of a method for training a trinary neural network.

FIG. 7 depicts an example computer system for operating a trinary neural network.

### DESCRIPTION

The description that follows includes example systems, methods, techniques, and program flows that may be included in embodiments of the disclosure. However, it is understood that this disclosure may be practiced without these specific details. For instance, this disclosure refers to trinary neural networks in illustrative examples where the output of a neuron is one of three integer values. Aspects of this disclosure can be also applied to neurons that output four, five or other relatively low numbers of possible output values. In other instances, well-known instruction instances, protocols, structures and techniques have not been shown in detail in order not to obfuscate the description.

Overview

Conventional neural networks include neurons receive floating-point and integer input data, apply floating-point coefficients to the input data, and apply one or more functions to the input data to produce a result that is typically a floating-point number. In contrast, the internal operations and the output of a neuron in trinary neural network described herein operates using integer data. For example, in some embodiments, a neuron in a trinary neural network produces one of three values that can be expressed in two bits representing 1, 0 and −1 (e.g., binary values 01, 00 and 11). These values can represent a vote for (01), a vote against (11), or an abstention (00). Alternatively, the values can represent confidence or belief in an input value. For example, the values can represent that the neuron believes the value input value (01), doesn't believe the input value (11), or doesn't care about the input value (00).

As will be appreciated from the above, some embodiments of the trinary neural network can be implemented for low-power, limited resource environments where it would either be impossible or impractical to implement a conventional neural network. Further, the operation of the trinary neural network in conventional computing environments can be more efficient and consume less resources (memory, processor etc.) than conventional neural networks.

Example Illustrations

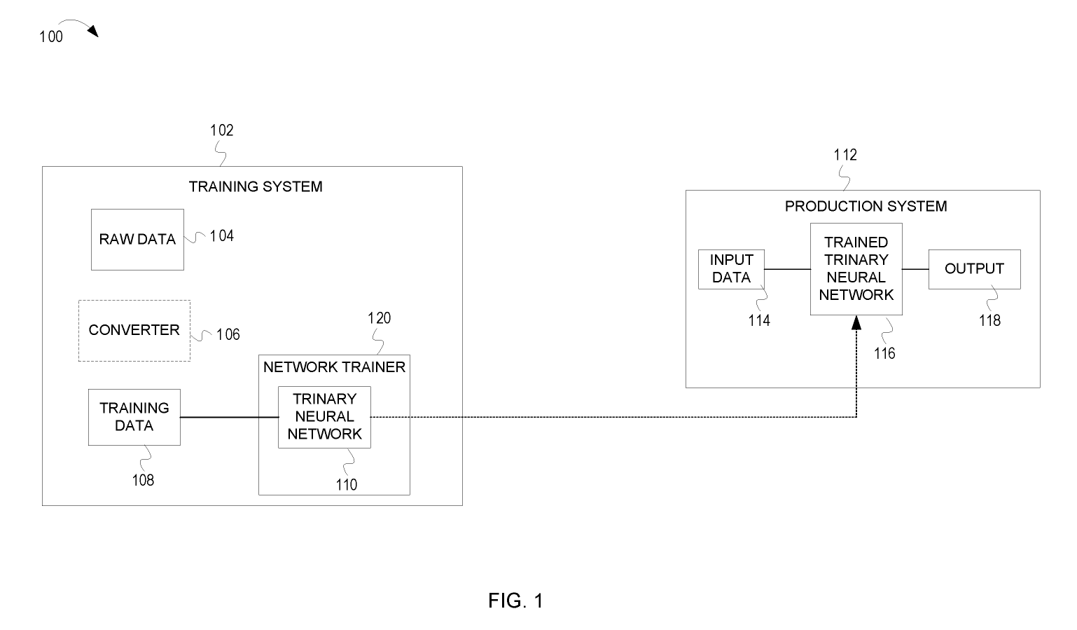

FIG. 1 is a block diagram illustrating an example system 100 for training and deploying a trinary neural network. In some embodiments, system 100 includes a training system 102 and a production system 112. Training system 102 can be a suitably configured computer system with sufficient processor, memory and other computing resources to allow the training system 102 to train a trinary neural network 110 in an acceptable time frame. For example, the training system 102 may be configured with both standard processors and special purpose processors, e.g., auxiliary processing units such as graphical processor units (GPUs), that can be configured for training a trinary neural network 110. The processors on training system 102 can have native support for floating-point operations.

Training system 102 can include a network trainer 120. Network trainer 120 can use novel feedforward and backpropagation techniques described in further detail below to train a trinary neural network 110 based on a set of training data 108.

After the training system 102 has completed training the trinary neural network 110, it can be deployed to production system 112 as trained trinary neural network 116. Production system 112 can be a computing system that has relatively less computing capability when compared with training system 102. For example, production system 112 may have less memory, slower processors, fewer processors, and fewer or no auxiliary processing units. Further, the processor(s) on production system 112 may lack native support for floating-point operations. Thus, a production system 112 may be an embedded system, a system on a chip, a smart-phone, or other low-power and/or limited resource computing system.

Production system 112 can use the trained neural network 116 to receive input data 114, and pass the input data 114 through the trained neural network 116 to obtain output 118.

System 100 can optionally include a converter 106. Converter 106 can be used to convert raw data 104 to a form that can be better utilized for training or operating a trinary neural network 110 or 116. For example, converter 106 can be used to convert floating point data to an integer representation. Floating point data in the raw data 104 can be binned, represented as a floating point number in binary, or other types of conversion.

As an example, consider a situation where the embedded sensors measure temperature various points in a building, and a neural network is to be used to determine whether to increase the temperature, decrease the temperature, or leave the temperature the same at the location corresponding to the sensor. The data elements and types in raw data 104 may include the following:

Location:
Latitude: Float;
Longitude: Float;

Current Temperature: Float

Output: Integer representing Heat, Cool or Do Nothing.

The converter 106 may translate the Latitude and Longitude to an integer representing a room number. The converter 106 may translate the Current Temperature to an integer bin identifier for bins representing High, Somewhat High, OK, Somewhat Low and Low temperatures.

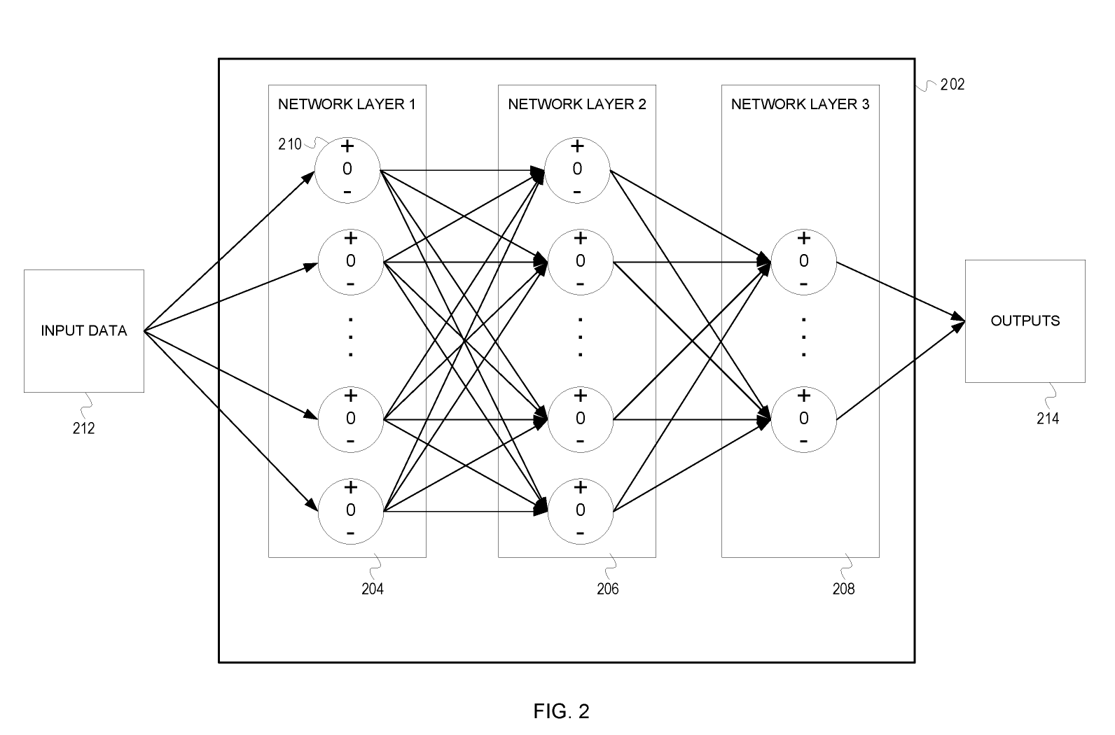

FIG. 2 is a block diagram illustrating an example trinary neural network 202. The example trinary neural network 202 includes three layers 204, 206 and 208. Each layer can have multiple voting neurons 210 that produce one of three values (indicated as “+”, “0” and “−”. There can be differing numbers of voting neurons in each layer. In some embodiments, the voting neurons in one layer are fully connected to the neurons in preceding and succeeding layers. That is, a voting neuron in one layer will receive input from every voting neuron in the preceding layer and will provide output to every voting neuron in a succeeding layer.

The neural network 202 can receive input data 212. The input data 212 can be integer data that is passed initially to each of the voting neurons in the first network layer 204. The voting neurons in the first network layer 204 process the input data as described below, and provide output to second network layer 206. The voting neurons in second network layer 206 processes the data received from the first network layer 204 and provide output to the third network layer 208. The outputs of the third network layer 208 are then used as outputs 214 of the neural network.

It should be noted that the example trinary neural network 202 presented in FIG. 2 has three layers. Those of skill in the art having the benefit of the disclosure will appreciate that a trinary neural network can have fewer or more layers, and will typically have more than three layers. Such configurations are within the scope of the inventive subject matter of the disclosure.

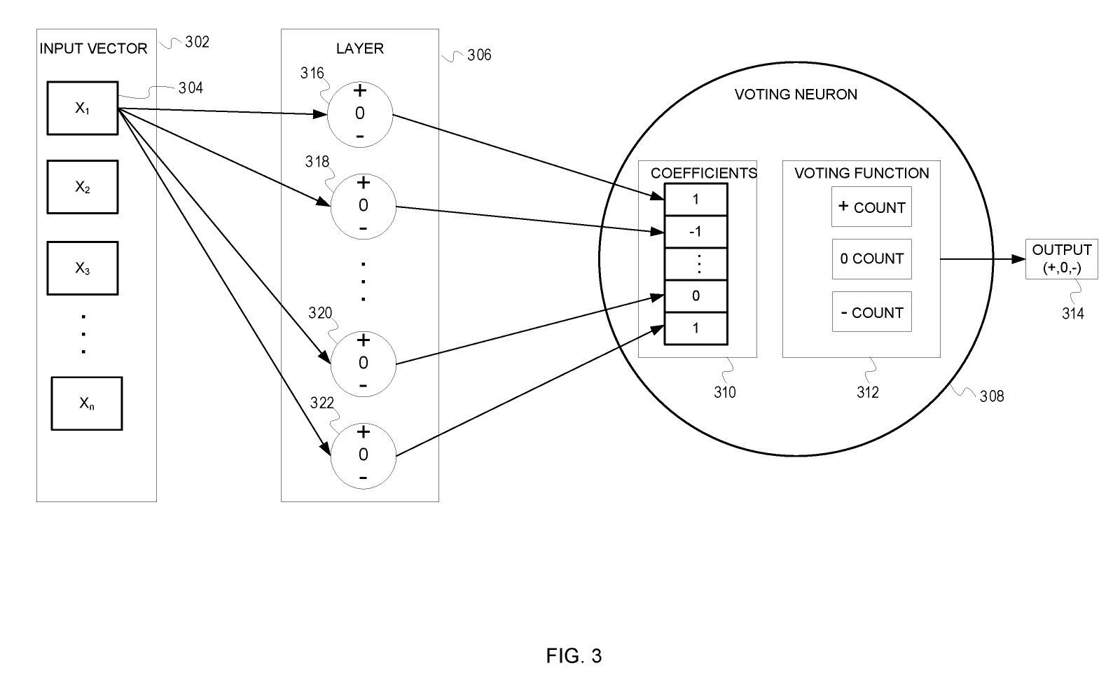

FIG. 3 is a block diagram providing further details on a voting neuron 308 in an example trinary neural network. In the example illustrated in FIG. 3, an input vector 302 is provided as input to a layer 306 of a trinary neural network. The input vector 302 can be a vector of integer data from an input data set if layer 306 is the first layer of the trinary neural network. Alternatively, the input vector 302 can be a set of outputs of neurons from a preceding layer of the neural network if layer 306 is not the first layer (i.e., layer 306 is a hidden layer).

For the purposes of the example illustrated in FIG. 3, assume that an input value x₁ 304 of an input vector 302 has been passed to each of the voting neurons in layer 306 of a trinary neural network. The voting neurons in layer 306 have provided their voting output to a neuron 308 in a succeeding layer (not shown). Voting neuron 308 can include coefficients 310 and a voting function 312. The coefficient values can represent how the voting neuron treats output values of voting neurons in the preceding layer. In some embodiments, a coefficient value of one (01) indicates that the voting neuron trusts the output value, a value of zero (00) indicates that the voting neuron does not care about the output value, and a value of negative one (11) indicates that the voting neuron does not trust the output value. The output value of a voting neuron in a previous layer can be multiplied by the coefficient value to determine a candidate output value for the voting neuron 308. Table 1 below provides the corresponding candidate output values for various combinations of input values and coefficients.

TABLE 1

| | | |
|---|---|---|
| Input Value from | | Candidate |
| Previous Layer | Coefficient | Output Value |

| | | | | | |
|---|---|---|---|---|---|
| 1 | (Vote For) | 1 | (Trust) | 1 | (Vote For) |
| 1 | (Vote For) | 0 | (Don't Care) | 0 | (Abstain) |
| 1 | (Vote For) | −1 | (Don't Trust | −1 | (Vote Against) |
| 0 | (Abstain) | 1 | (Trust) | 0 | (Abstain) |
| 0 | (Abstain) | 0 | (Don't Care) | 0 | (Abstain) |
| 0 | (Abstain) | −1 | (Don't Trust) | 0 | (Abstain) |
| −1 | (Vote Against) | 1 | (Trust) | −1 | (Vote Against) |
| −1 | (Vote Against) | 0 | (Don't Care) | 0 | (Abstain) |
| −1 | (Vote Against) | −1 | (Don't Trust) | 1 | (Vote For) |

In the example illustrated in FIG. 3, the coefficients 310 of voting neuron 308 indicate that the voting neuron 308 trusts output from voting neuron 316 and voting neuron 322, doesn't care what the output is from voting neuron 320, and doesn't trust the output of voting neuron 318.

When voting neuron 308 determines a candidate output value based on the output of a voting neuron in a previous layer, the voting neuron can increment a count associated with the candidate value. In other words, voting neuron maintains a count of all of the votes (as modified by the coefficient associated with the input value) of the voting neurons in the previous layer.

After all neurons in the preceding layer 306 have provided their output value to voting neuron 308, the voting neuron can execute voting function 312 to determine an output 314 for the voting neuron. In some embodiments, the voting function 312 determines which candidate output value (1, 0, or −1) received the most votes. The candidate output value receiving the highest number of votes is selected as the output value 314 for the voting neuron 308. The voting neuron 308 can reset the counts to zero for the next pass of data through the voting neuron 308.

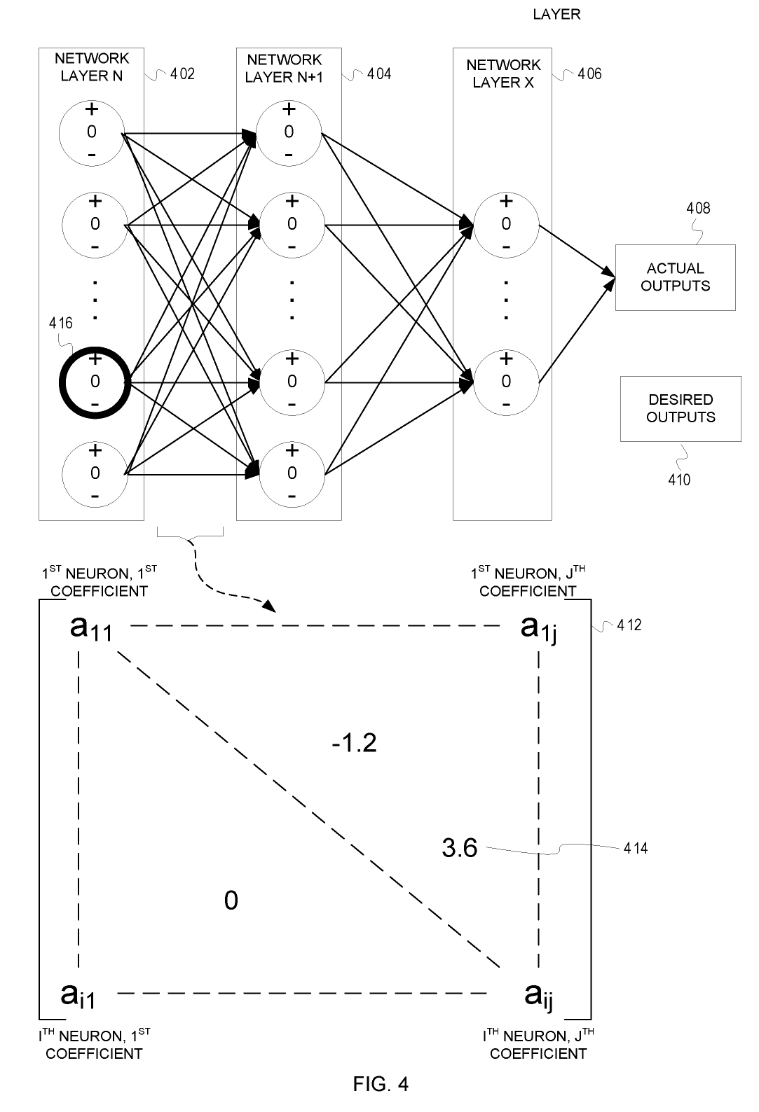

FIG. 4 is a block diagram illustrating elements involved in backpropagation in an example trinary neural network. In the example illustrated in FIG. 4, the example trinary neural network has x layers, with layers n 402 and layer n+1 404 comprising hidden layers prior to the final layer x 406. The example trinary neural network has produced outputs 408 during a training run of the neural network. The outputs 408 can be compared to desired outputs 410. The desired outputs 410 are typically known prior to training the network, and are the results considered to be the correct outputs corresponding to the given input data. The comparison of the desired outputs 410 with the actual output 408 determines one or more errors in the actual outputs.

During a conventional backpropagation step, backpropagation matrices are calculated. Each backpropagation matrix has entries that are adjustments in the coefficients of the voting neurons in a layer that, if applied, would change the output of the voting neurons to the voting neurons in a subsequent layer in order to reduce or eliminate errors in the actual output. In the example illustrated in FIG. 4, the values in the entries in backpropagation matrix 412 are adjustments to the coefficients of voting neurons in network layer n 402 that, if applied, would change the output of the layer n voting neurons to the voting neurons in layer n+1 404. Each row in backpropagation matrix 412 comprises the adjustments to the coefficients in a particular voting neuron, and a column in the row is the adjustment for a particular coefficient of the associated voting neuron. In the example illustrated in FIG. 4, several example entries have been provided, while most entries are omitted to avoid cluttering the figure. As an example, during a backpropagation step, a value of 3.6 was calculated for entry 414 as the adjustment to a coefficient in voting neuron 416 needed to reduce the error in the actual output 408 with respect to the desired output 410.

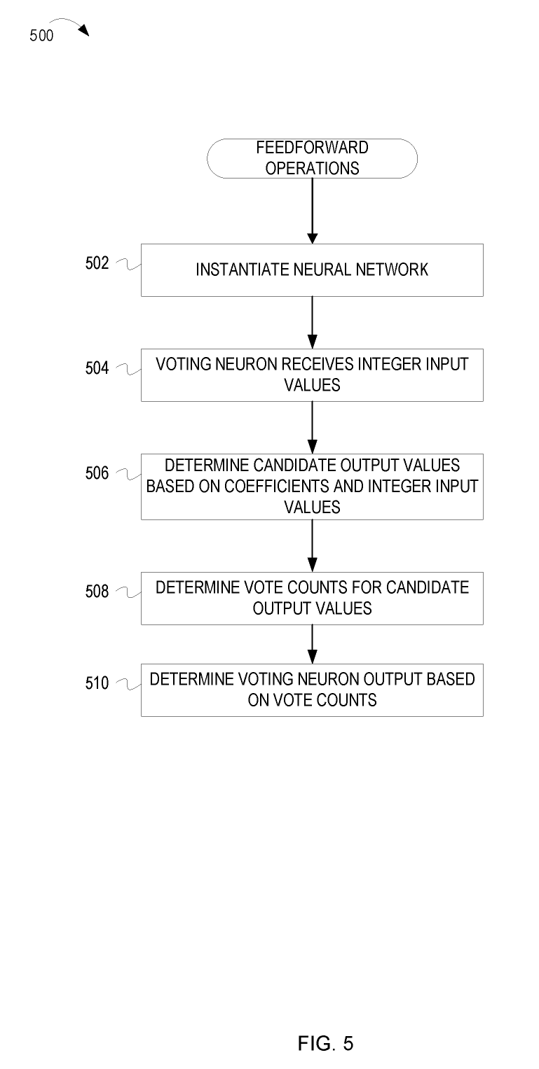

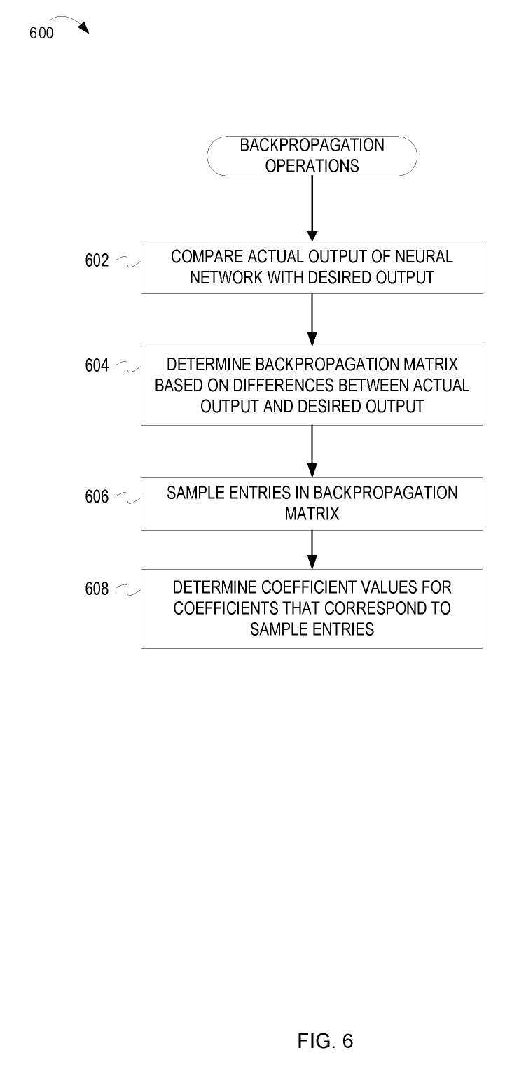

Further details on the operation of a trinary neural network are provided below with respect to FIGS. 5 and 6.

FIG. 5 is a flow chart 500 illustrating feedforward operations of a method for operating a trinary neural network. At block 502, a neural network is instantiated. The neural network can be instantiated in various ways. For example, a previously trained neural network can be instantiated by reading the neural network configuration (e.g., the layers, neurons, and neuron coefficients) from one or more machine-readable media. Alternatively, a new neural network, i.e., a network to be trained, can be instantiated by configuring the layers and neurons in the new neural network.

At block 504, a voting neuron can receive integer input values. In the case of a first layer of the trinary neural network, the voting neuron can receive input values from the input data to the neural network. The input data can be from a set of training data in the case of a training pass through the trinary neural network, or from operational data in the case of a trained trinary neural network that has been deployed to a production system. Hidden layers can receive input data from voting neurons in the preceding layer.

At block 506, the voting neuron determines candidate output values based on the input received at block 506 and the coefficients of the voting neuron. As described above with reference to FIG. 3, the coefficient values can represent how the voting neuron treats output values of voting neurons in the preceding layer. The output value of a voting neuron in a previous layer can be multiplied by the coefficient value to determine a candidate output value for the voting neuron. Thus, there can be a candidate output value for each input received by the voting neuron.

At block 508, the voting neuron determines vote counts for each candidate value. The voting neuron can maintain a vote count for each possible output value (−1, 0, 1) and can increment the count based on the results of applying the coefficient for an input to the input value received by the voting neuron from the voting neuron in the previous layer. For example, if the voting neuron receives a value of 1 from a voting neuron in the previous layer and the associated coefficient is −1, the candidate output value is −1. The voting neuron can increment the count of votes associated with the candidate value −1.

After all inputs from the voting neurons in the previous layer have been received by the voting neuron, the voting neuron can determine its output based on the vote counts associated with each candidate output value. In some embodiments, the candidate value with the most votes becomes the output for the voting neuron. For example, if the candidate value “1” received the most votes, then the voting neuron would output a value of “1.” In the case of a tie between candidate output values, the voting neuron can output a value of zero (abstain).

Blocks 504-510 can be repeated for each of the voting neurons in a layer, and can also be repeated for each layer in the trinary neural network.

FIG. 6 is a flow chart 600 illustrating backpropagation operations of a method for training a trinary neural network. At block 602, the actual output of a trinary neural network with respect to a particular set of inputs are compared with the desired output for the particular set of inputs.

At block 604, one or more backpropagation matrices can be determined based on the difference between the actual output and the desired output. As discussed above with respect to FIG. 4, the backpropagation matrices have entries that are adjustments in the coefficients of the voting neurons in a layer that, if applied, would change the output of the voting neurons to the voting neurons in a subsequent layer to reduce or eliminate errors in the actual output. Conventional backpropagation methods now known or developed in the future can be used to generate the backpropagation matrices.

In some embodiments, not all entries in a backpropagation matrix are applied to the coefficients of the voting neurons. For example, in some embodiments, the backpropagation matrix is sampled at block 606 to determine a subset of entries in the backpropagation matrix that will be applied to coefficients of voting neurons in a layer. The size of the sample can be a relatively small percentage of the entries in the backpropagation matrix. As an example, the sample size may be less than 10%, or even less than 1% of the entries in the backpropagation matrix. Further, the sample size can change as the trinary neural network is being trained. For example, the sample size may start at 5% of the entries, and change over subsequent training runs to a value of less than 1%. The amount of change can be driven by a schedule. For example, the sample size can start at an initial percentage of the backpropagation matrix, and then decay in subsequent training iterations per a predefined or configurable schedule or rate.

In some embodiments, a probability sampling is used, where the probability of an entry being selected for inclusion in the sample is weighted by the absolute value of the entry. As discussed above, the entries in a matrix are the change in coefficient values that reduce or eliminate errors in the actual output. Thus, a larger magnitude of change can have a correspondingly greater effect in reducing the error in the actual output. Thus, in some embodiments, the probability of selection of an entry is weighted to favor entries having a larger absolute value. For instance, in the example backpropagation matrix 412 (FIG. 4), the entry 414 having a value of 3.6 has a greater probability of being included in a sample than the entry having a value of −1.2 (i.e., |3.6|>|−1.2|. In some embodiments, entries having a value of 0 are not included in any samples.

While probability sampling is desirable, other sampling methodologies could be used. For example, a random sampling could be used to select a sample of the entries in a backpropagation matrix, where each entry of the backpropagation matrix has an equal probability of being selected.

At block 608, the coefficient values for the voting neurons in a layer that correspond to the selected entries sampled from the backpropagation matrix are determined. As noted above, conventional backpropagation methods can be used to calculate the backpropagation matrix. However, this can often result in values in the backpropagation matrix that exceed the allowable −1, 0 and 1 values for a coefficient in the trinary neural network. Thus, the sampled entries are used to indicate a direction of change for a coefficient value. For example, if the value of an entry is greater than zero (0), then the corresponding coefficient is adjusted up. Thus, a coefficient value of −1 becomes 0, and a coefficient value of 0 becomes 1. Similarly, if the value of an entry is less than zero, then the value of the corresponding coefficient is adjusted down. Thus, a coefficient value of 1 is adjusted downward to 0, and a coefficient value of 0 is adjusted downward to −1. If the current coefficient value of a voting neuron is already at the maximum value of 1, no further adjustment upward will be performed regardless of a positive value of the corresponding sampled entry of the backpropagation matrix. Similarly, if the current coefficient value of a voting neuron is already at the minimum value of −1, then no further downward adjustment is performed regardless of a negative value of the corresponding sampled entry.

Using the backpropagation matrix 412 of FIG. 4 as an example, if the value 3.6 of entry 414 were selected for inclusion in the sampled subset, the corresponding coefficient in voting neuron 416 would be adjusted upward by 1 if not already at the value 1. Similarly, if the value −1.2 were included in the sampled subset, then the corresponding coefficient in the voting neuron would be adjusted downward if not already at the minimum value of −1.

After all coefficient values corresponding to the sampled entries in the backpropagation matrix for the current layer have been determined, blocks 604-608 can be repeated for other layers of the trinary neural network.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

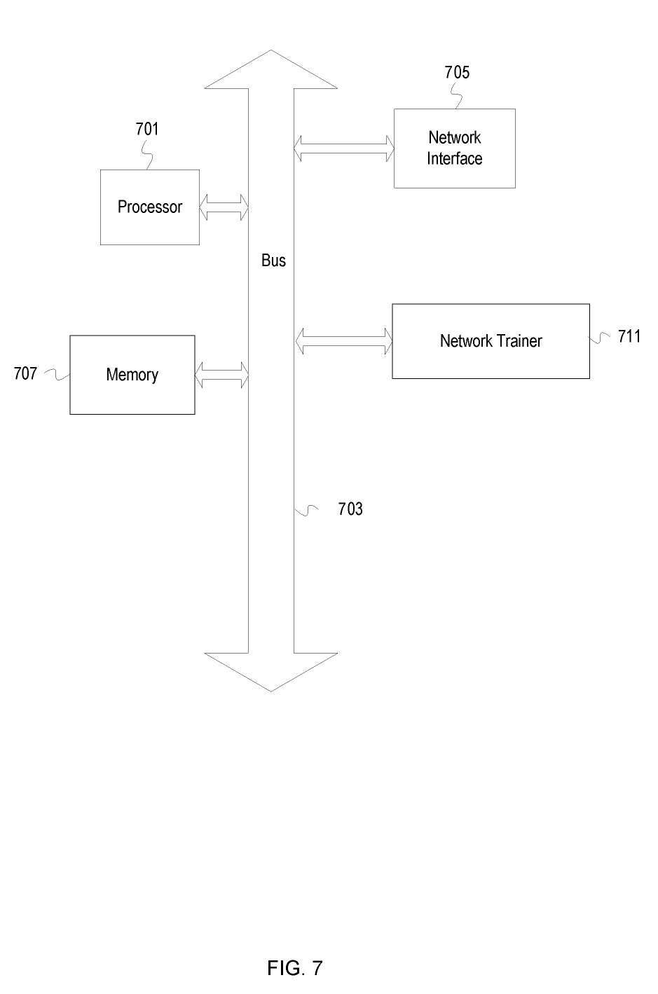

FIG. 7 depicts an example computer system for operating a trinary neural network. The computer system includes a processor unit 701 (possibly including multiple processors, multiple cores, multiple nodes, and/or implementing multi-threading, etc.). The computer system includes memory 707. The memory 707 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 703 (e.g., PCI, ISA, PCI-Express, HyperTransport® bus, InfiniBand® bus, NuBus, etc.) and a network interface 705 (e.g., a Fiber Channel interface, an Ethernet interface, an internet small computer system interface, SONET interface, wireless interface, etc.). The system also includes a network trainer 711. The network trainer 711 can be used to train a trinary neural network using the structure and methods described above. Any one of the previously described functionalities may be partially (or entirely) implemented in hardware and/or on the processor unit 701. For example, the functionality may be implemented with an application specific integrated circuit, in logic implemented in the processor unit 701, in a co-processor on a peripheral device or card, etc. Further, realizations may include fewer or additional components not illustrated in FIG. 7 (e.g., video cards, audio cards, additional network interfaces, peripheral devices, etc.). The processor unit 701 and the network interface 705 are coupled to the bus 703. Although illustrated as being coupled to the bus 703, the memory 707 may be coupled to the processor unit 701.

While the aspects of the disclosure are described with reference to various implementations and exploitations, it will be understood that these aspects are illustrative and that the scope of the claims is not limited to them. In general, techniques for performing feedforward and/or backpropagation operations in a trinary neural network as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### Terminology

As used herein, the term “or” is inclusive unless otherwise explicitly noted. Thus, the phrase “at least one of A, B, or C” is satisfied by any element from the set {A, B, C} or any combination thereof, including multiples of any element.

What is claimed is:

1. A method comprising:
instantiating a neural network having a plurality of voting neurons arranged in one or more layers;
receiving, by a voting neuron of the plurality of voting neurons, a plurality of integer input values;
determining, by the voting neuron based at least in part on a set of voting coefficients, vote counts associated with a plurality of candidate output values; and
determining an output of the voting neuron based, at least in part, on the vote counts.

2. The method of claim 1, wherein determining an output of the voting neuron, based at least in part, on the vote counts comprises:
determining the output for the voting neuron as a candidate output value of the plurality of candidate values with a highest vote count.

3. The method of claim 1, wherein determining the output of the voting neuron comprises determining one of a value representing a vote for, a vote against, and an abstention.

4. The method of claim 1, wherein the plurality if input integer values comprise two-bit values.

5. The method of claim 1 further comprising:
comparing an actual output of the neural network with a desired output of the neural network;
determining, based on the comparison, a backpropagation matrix;
sampling a plurality of entries from the backpropagation matrix to determine a sampled subset of the backpropagation matrix; and
for each entry in the sampled subset, determining a value for a coefficient of a voting neuron associated with the entry in accordance with the entry.

6. The method of claim 5, wherein determining a value for the coefficient of the voting neuron associated with the entry in accordance with the entry comprises:
increasing the coefficient by one step based on determining that the entry is a positive value; and
decreasing the coefficient by one step based on determining that the entry is a negative value.

7. The method of claim 5, wherein sampling the plurality of entries from the backpropagation matrix comprises performing a probability sampling of the plurality of entries from the backpropagation matrix.

8. One or more non-transitory machine-readable media comprising program code for processing a trinary neural network, the program code to:
instantiate a neural network having a plurality of voting neurons arranged in one or more layers;
receive, by a voting neuron of the plurality of voting neurons, a plurality of integer input values;
determine, by the voting neuron based at least in part on a set of voting coefficients, vote counts associated with a plurality of candidate output values; and
determine an output of the voting neuron based, at least in part, on the vote counts.

9. The one or more non-transitory machine-readable media of claim 8, wherein the program code to determine the output of the voting neuron, based at least in part, on the vote counts comprises program code to:
determine the output for the voting neuron as a candidate output value of the plurality of candidate output values with a highest vote count.

10. The one or more non-transitory machine-readable media of claim 8, wherein the program code to determine the output of the voting neuron comprises program code to determine one of a value representing a vote for, a vote against, and an abstention.

11. The one or more non-transitory machine-readable media of claim 8, wherein the plurality if input integer values comprise two-bit values.

12. The one or more non-transitory machine-readable media of claim 8, wherein the program code further comprises program code to:
compare an actual output of the neural network with a desired output of the neural network;
determine, based on the comparison, a backpropagation matrix;
sample a plurality of entries from the backpropagation matrix to determine a sampled subset of the backpropagation matrix; and
for each entry in the sampled subset, determine a value for a coefficient of a voting neuron associated with the entry in accordance with the entry.

13. The one or more non-transitory machine-readable media of claim 12, wherein the program code to determine a value for the coefficient of the voting neuron associated with the entry in accordance with the entry comprises program code to:
increase the coefficient by one step based on determining that the entry is a positive value; and
decrease the coefficient by one step based on determining that the entry is a negative value.

14. The one or more non-transitory machine-readable media of claim 12, wherein the program code to sample the plurality of entries from the backpropagation matrix comprises program code to perform a probability sampling of the plurality of entries from the backpropagation matrix.

15. An apparatus comprising:
at least one processor; and
a non-transitory machine-readable medium having program code executable by the at least one processor to cause the apparatus to,
instantiate a neural network having a plurality of voting neurons arranged in one or more layers,
receive, by a voting neuron of the plurality of voting neurons, a plurality of integer input values,
determine, by the voting neuron based at least in part on a set of voting coefficients, vote counts associated with a plurality of candidate output values, and
determine an output of the voting neuron based, at least in part, on the vote counts.

16. The apparatus of claim 15, wherein the program code to determine the output of the voting neuron, based at least in part, on the vote counts comprises program code to:
determine the output for the voting neuron as a candidate output value of the plurality of candidate values with a highest vote count.

17. The apparatus of claim 15, wherein the program code to determine the output of the voting neuron comprises program code to determine one of a value representing a vote for, a vote against, and an abstention.

18. The apparatus of claim 15, wherein the program code further comprises program code to:
compare an actual output of the neural network with a desired output of the neural network;
determine, based on the comparison, a backpropagation matrix;
sample a plurality of entries from the backpropagation matrix to determine a sampled subset of the backpropagation matrix; and
for each entry in the sampled subset, determine a value for a coefficient of a voting neuron associated with the entry in accordance with the entry.

19. The apparatus of claim 18, wherein the program code to determine a value for the coefficient of the voting neuron associated with the entry in accordance with the entry comprises program code to:
increase the coefficient by one step based on determining that the entry is a positive value; and
decrease the coefficient by one step based on determining that the entry is a negative value.

20. The apparatus of claim 18, wherein the program code to sample the plurality of entries from the backpropagation matrix comprises program code to perform a probability sampling of the plurality of entries from the backpropagation matrix.
